(19) United States
(12) Patent Application Publication
(10) Pub. No.: US 2026/0014627 A1
(43) Pub. Date: Jan. 15, 2026

(54) Systems and Methods for High Performance Metal Droplet Ejection Via Meniscus Control Enabled by Multi-Part Ejection Nozzle

(71) Applicant: Lawrence Livermore National Security, LLC, Livermore, CA (US)

(72) Inventors: Viktor SUKHOTSKIY, Livemore, CA (US); Alexander BAKER, Livermore, CA (US); Eric S. ELTON, Livermore, CA (US); Jesse Thomas AHLQUIST, San jose, CA (US); Hunter Bryant HENDERSON, Livermore, CA (US)

(21) Appl. No.: 18/773,075

(22) Filed: Jul. 15, 2024

(51) Int. Cl. B22F 12/53; B33Y 30/00

(52) U.S. Cl. CPC B22F 12/53; B33Y 30/00

(57) ABSTRACT

The present disclosure relates to a liquid metal jetting ejection nozzle having a nozzle main body and a wetting plate. The nozzle main body has an enlarged opening at a distal end through which a molten metal feedstock material flows during a liquid metal jetting operation, and is formed from a first material having a first wetting characteristic. The wetting plate has an aperture and is secured to the enlarged opening of the nozzle main body. The wetting plate has a second wetting characteristic of a magnitude less than the first wetting characteristic to at least inhibit wetting. This two piece nozzle construction enables optimum materials and construction/fabrication techniques to be used for both components, thus improving performance, durability and reliability of the ejection nozzle.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for liquid metal jetting (LMJ), and more particularly to a multi-piece nozzle which eases component fabrication, prolongs the duration for printing by eliminating or significantly reducing random events that affect proper droplet formation, and significantly improves upon consistently and repeatably locating the meniscus of a droplet at an ideal location relative to an ejection orifice of the nozzle, to provide improved ejection of molten droplets, while increasing the frequency at which droplets may be ejected, significantly reducing nozzle clogging, and extending printing duration.

### BACKGROUND

The statements in this section merely provide background information related to the present disclosure and may not constitute prior art.

One of the ways the nozzle requirements for Liquid Metal Jetting (LMJ) systems are different than other fluid ejection methods is the location of the liquid metal meniscus, i.e., the interface between the molten metal and the outside environment (usually inert gas). The location of the meniscus just before the initiation of the ejection cycle is critical to the formation of the droplet. This is because the initial stages of each droplet ejection are very sensitive to the shape, location and initial condition of the meniscus. In addition, certain meniscus conditions can lead to uncontrollable dripping of the fluid, creating unwanted ejections and other failure modes such as reactions on the outer surface of the nozzle, which make it difficult to accurately and reliably control the ejections.

The most favorable location of the meniscus contact line is where the contact line rests at the exit of the orifice by default. This is shown in FIG. 1d. Undesirable meniscus locations are shown in FIGS. 1a, 1b and 1c. By making the inner surface of the orifice wetting and the outer surface non-wetting the meniscus will naturally reside in the location shown in FIG. 1d. The wetting/non-wetting interface is critical to this effect. On the practical side, there are challenges to manufacturing and using refractory nozzle designs that limit applicability and scalability. Current designs are monobody, meaning the main body and orifice(s) are made from a single starting material. This means there is no flexibility to manufacturing; the nozzle material must be available in >1 in³ pieces, be bulk-machinable to a fine surface finish, present favorable wetting conditions for every molten metal and alloy, and have favorable hardness properties to allow reliable small orifice drilling. Limited reactivity, while also being wettable, could be an additional limitation. This is quite limiting in the space of refractory materials. For LMJ of aluminum alloys, only graphite and hexagonal boron nitride (hBN) meet all of these requirements, and high quality hBN is expensive in this size range. Vice versa, many liquid metals of interest for jetting are chemically incompatible with graphite, restricting the general applicability of LMJ. If nozzles could be produced from more exotic refractory metals and ceramics that have favorable compatibility with the molten metal, then LMJ technology would be even more broadly applicable.

With regard to droplet ejection from a nozzle, a performance concern with previously existing LMJ nozzles concerns the oscillation or “bouncing” of the meniscus between droplet ejections. Whenever a droplet is ejected, the liquid metal meniscus will move up and down inside the nozzle exit orifice until it naturally settles after some finite time. Reducing the oscillation time is critical to increasing the droplet ejection frequency, and thus, the deposition rate of the process. Uncontrolled meniscus locations lead to long oscillation periods and thus, low ejection frequencies. Since deposition rate is one of the current limiting factors for all AM processes, addressing this issue constitutes a major advancement. In droplet-on-demand LMJ,

Still another performance limitation with preexisting nozzles used in LMJ systems is the tendency to periodically “clog.” By “clog”, it is meant that jetting material becomes stuck in the nozzle exit orifice from oxidation or from contaminants resulting from reactions between the molten metal the nozzle walls. To remedy this problem, the nozzles either need to be redrilled to a larger diameter, or replaced with a new nozzle. Both approaches are detrimental for the economics, usability and scalability of LMJ.

Finally, although there is some existing literature describing nozzle design and meniscus control for ink-jetting, few of these previously known techniques are applicable to molten metals. Thus, there is a need for a high performance nozzle for jetting multiple liquid metals efficiently in an LMJ system.

### SUMMARY

This section provides a general summary of the disclosure, and is not a comprehensive disclosure of its full scope or all of its features.

In one aspect the present disclosure relates to a liquid metal jetting ejection nozzle. The jetting nozzle may comprise a nozzle main body having an enlarged opening at a distal end through which a molten metal feedstock material flows during a liquid metal jetting operation. The nozzle main body may be formed from a first material having a first wetting characteristic. The ejection nozzle may also comprise a wetting plate having an aperture. The wetting plate is secured to the enlarged opening of the nozzle main body. The wetting plate has a second wetting characteristic of a magnitude less than the first wetting characteristic to at least inhibit wetting.

In another aspect the present disclosure relates to a liquid metal jetting ejection nozzle. The ejection nozzle may comprise a nozzle main body having an interior area and an enlarged opening at a distal end through which a molten metal feedstock material flows through from the interior area during a liquid metal jetting operation. The ejection nozzle may also include a wetting plate secured to the enlarged opening. The wetting plate has a first surface forming an inside surface facing the interior area of the nozzle main body, a second surface opposing the first surface and forming an outer surface facing away from the interior area, and an aperture through which the liquid metal is jetted during the liquid metal jetting operation. The inside surface of the wetting plate has a first wettability and the outside surface of the wetting plate having a second wettability less than the first wettability to at least inhibit wetting.

In still another aspect the present disclosure relates to a method of using a liquid metal ejection nozzle to control a location of a meniscus at an ejection aperture of the nozzle. The method may comprise providing a nozzle main body for the liquid metal ejection nozzle to contain a quantity of a liquid metal within an interior area thereof, and feeding the liquid metal through an enlarged opening at a distal end of the nozzle main body. The method may further include using an independent wetting plate having an aperture. The wetting plate has an inside surface facing the interior area of the nozzle main body, and is secured over the enlarged opening at the distal end of the nozzle main body. The wetting plate ejects droplets of the liquid metal through the aperture. The wetting plate also has an inner surface which faces the interior area of the nozzle main body, and which has a first degree of wettability to promote wetting, and an outer surface which opposes the inner surface has a second degree of wettability which inhibits wetting. The wetting plate helps to control a location of the meniscus such that the meniscus is contained uniformly and substantially within a cross section of the wetting plate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIGS. 1a-1d are prior art illustrations showing undesirable meniscus locations at the ejection orifice of a conventional LMJ nozzle, while FIG. 1d shows a desirable location for the meniscus;

FIG. 2a is a cross sectional side view of an ejection nozzle in accordance with one embodiment of the present disclosure;

FIG. 2b is a highly enlarged view of the ejection nozzle of FIG. 2a showing in greater detail the wetting element;

FIG. 3a is a side view of a LMJ ejection nozzle in accordance with another embodiment of the present disclosure, wherein the wetting element incorporates a plurality of apertures rather than just a single aperture;

FIG. 3b is a highly enlarged view of the ejection nozzle of FIG. 3a showing in greater detail the multi-apertured wetting element;

FIG. 3c shows another example of a wetting element in accordance with the present disclosure having a plurality of concentrically arranged apertures;

FIG. 3d shows an enlarged, side cross sectional view of a wetting element in accordance with another embodiment of the present disclosure where the aperture in the wetting element is formed with a tapering wall;

FIG. 3e shows an enlarged, side cross sectional view of a wetting element in accordance with another embodiment of the present disclosure where the aperture in the wetting element is formed with a trumped shape;

FIG. 4 is an image of six wetting elements made form a Tantalum material sheet, and having been laser drilled to produce a 500 μm aperture in each, and vapor coated on one side (facing up in the figure) with Al₂O₃;

FIG. 5 is an enlarged bottom view of a conventional nozzle housing bored out to accommodate mounting a wetting plate of the present disclosure thereto;

FIG. 6 is a bottom view of the nozzle of FIG. 5 with a wetting plate from FIG. 4 (i.e., made in accordance with the present disclosure) positioned over the opening, coated side facing up, ready to be fixedly secured thereto;

FIG. 7 shows the wetting plate and nozzle of FIG. 6 with the wetting plate bonded thereto via graphite paste, and subsequently heat treated; and

FIG. 8 is a flowchart chart showing one example of various operations that may be performed in manufacturing an LMJ ejection nozzle in accordance with the present disclosure.

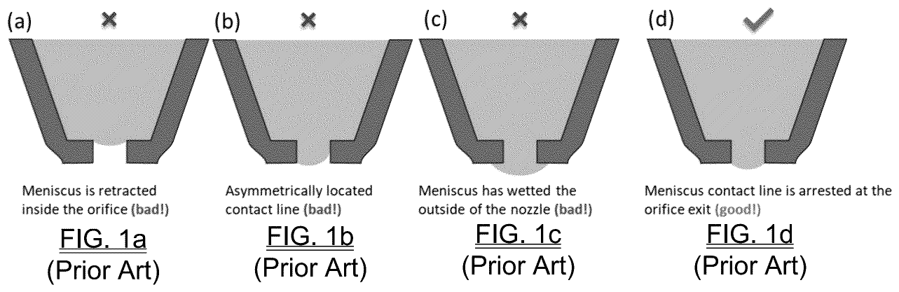

### DETAILED DESCRIPTION

Example embodiments will now be described more fully with reference to the accompanying drawings.

The present disclosure addresses several challenges and limitations associated with the performance of present day ejection nozzles used in LMJ systems and methods:
nozzle fabrication methods that make the nozzle manufacturing process efficient and compatible with any LMJ system that employs a nozzle;
an orifice fabrication method that enables advanced production of smaller orifices (i.e. laser drilling), or orifices with unusual shapes (square, triangle, star, etc.), leading to potential improvements in printing resolution and speed; or orifices with varying diameters, leading to the ability to create multi-resolution nozzles.
a method for repeatable arresting of the meniscus contact line at an optimum location at the exit of the nozzle for efficient metal droplet ejection;
a method for rapid and repeatable LMJ system initialization (meniscus pinning), which doesn't require buildup of a chemical reaction layer to produce desired wetting behavior, ultimately resulting in quicker startup and turn-around time;
a method by which meniscus “bouncing” can be dampened, increasing the effective droplet ejection frequency that can be achieved without resulting in degraded performance;
an improvement in functional robustness, especially with regard to cleaning unwanted contaminants from the area around the orifice of the ejection nozzle;
re-use of nozzle bodies, which are often treated as disposables in LMJ processes; and
the ability to decouple the fabrication of a nozzle main body from fabrication of an associated wetting plate used at the nozzle orifice, which enables optimum materials 14 and machining/fabrication techniques to be used for both components to significantly improve reliability, durability and performance of the nozzle.

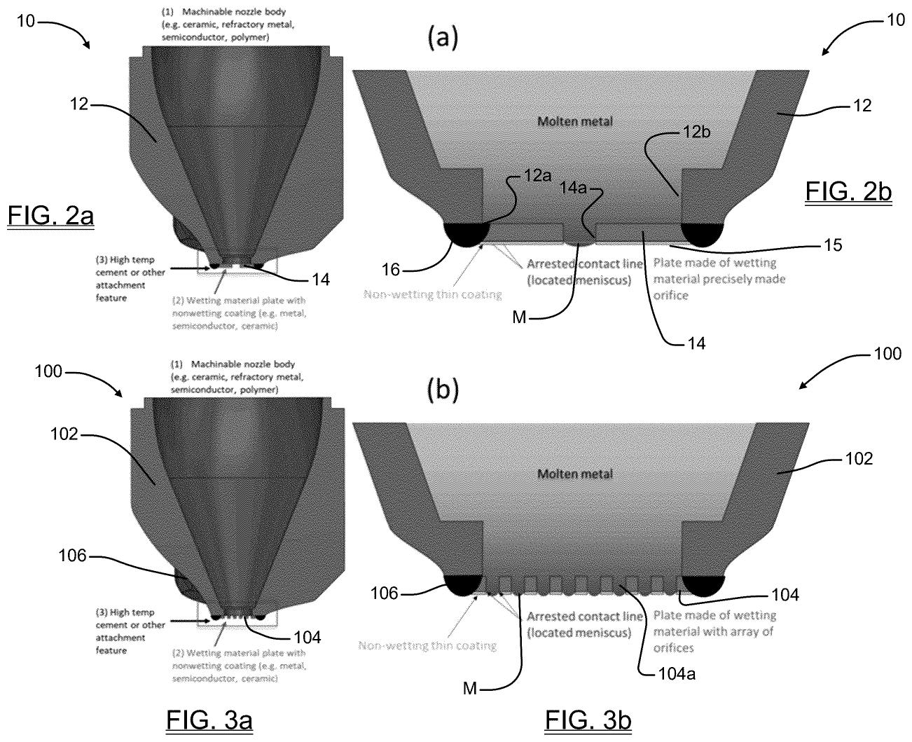

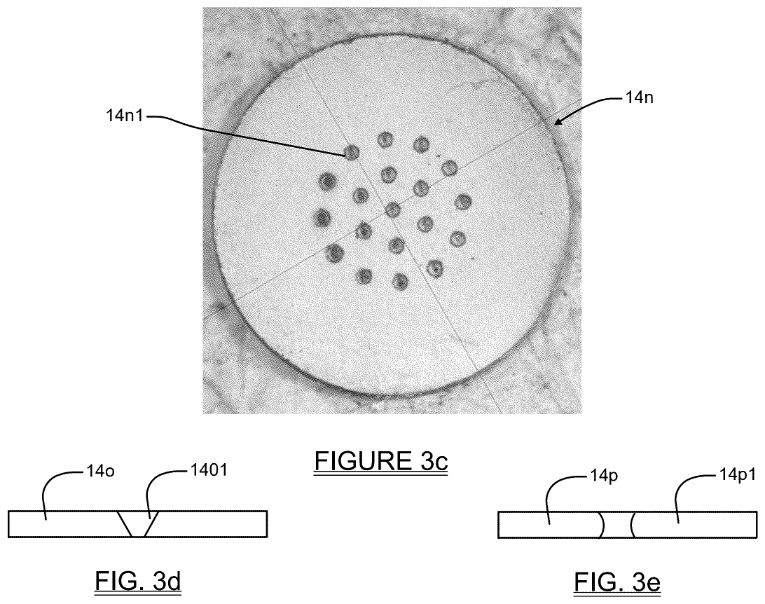

Referring now to FIGS. 2a and 2b, an ejection nozzle 10 (hereinafter simply “nozzle 10”) is shown in accordance with one embodiment of the present disclosure. In this example the nozzle 10 has a main body portion 12 and a wetting element 14. The wetting element 14 in this example forms a flat plate, and will be referred to throughout the following discussion simply as “wetting plate 14”.

The wetting plate 14 may be secured to a distal end 12a (i.e., exit aperture) of the nozzle main body 12, directly over an enlarged opening 12b at the distal end, and such that an aperture 14a of the wetting plate is concentrically aligned with the enlarged opening 12b of the nozzle main body 12. However, this is but one example, and in some implementations it may be preferred that the aperture 14a of the wetting plate 14 not be perfectly concentric with the enlarged opening 12b of the nozzle main body.

FIG. 2b shows the wetting plate 14 in highly enlarged fashion. The securing of the wetting plate 14 may be by any suitable means including, and without limitation, a suitable high temperature adhesive (e.g., graphite cement), laser welding, electron beam welding, reactive adhesion or a mechanical means such as threading, locking and press fitting. In this example a non-wetting coating 15 is applied to the downwardly facing surface of the wetting plate 14. In some embodiments the coating 15 may vary in thickness between about 0.5 μm to about 5 μm. The meniscus “M” is contained uniformly and substantially (i.e., virtually 100%) within a cross sectional thickness of the aperture 14a of the wetting plate 14. Again, this is the most desirable location for the meniscus to be formed at, and leads to optimum droplet formation and consistent, repeatable and high repetition rate droplet ejection.

FIGS. 2a and 2b also show a circumferential bead of high temperature adhesive 16 being used to effect the attachment. Attachment may also be effected by resettable means, where “resettable is understood to mean a configuration where the wetting plate 14 is readily removable, replaceable and re-installable. Such resettable means may include, without limitation, a male/female threaded engagement between the wetting plate 14 and the distal end 12a of the nozzle 12, a nozzle clamping system using mechanical clamps or high temperature springs which hold the wetting plate 14 securely in place to the distal end over the aperture 12b, or even a press/friction fit between a peripheral portion of the wetting plate 14 and the distal end 12a of the nozzle main body 12. If a welding operation is used to effect the attachment, then the attachment may be considered to be permanent. Resettable attachment methods allow the user to re-use nozzle main body 12, which can be highly advantageous if the nozzle main body material is expensive or the main body is of a design which is difficult and/or expensive to make. Optionally, the wetting plate 14 could even be attached to the outside of the nozzle body 12, or inside the nozzle body, with a relevant stopper feature to prevent the wetting plate from falling out. A stopper feature may be a simple ledge on the inside contour of nozzle body 12 or other components dedicated to the function.

The nozzle main body 12 can be made of any suitable high temperature material. In some implementations the nozzle main body 12 may be made from, without limitation, graphite or a different metal, ceramic, composite or other refractory material that is favorable to manufacture into the specific desired nozzle shape. It is especially important to note that by de-coupling the wetting plate 14 from the nozzle main body 12, the dimensional tolerance requirement for this process step is significantly reduced, opening possibilities to conventional techniques such as CNC milling, casting, powder sintering, investment casting, forging, lathe turning, additive manufacturing, etc. Conventional materials from the casting industry can also be used, given that these materials are often non-wetting for molten metal containment and are able to withstand multiple uses before replacement. The exact nozzle shape will depend on many factors, possibly including the types of parts being made, the materials being used to make the parts, the mechanical and thermal properties of the materials being used to make the nozzle parts, the shape and type of parts being made, and the operating conditions of the printhead, among other factors. In some implementations, manufacturing the distal end 12a of the nozzle main body 12 with a circumferential recess/shoulder or locating groove feature may help to make centering and attaching the nozzle plate easier and more repeatable. In some embodiments the material for making the nozzle main body 12 may include, by way of example and without limitation: tungsten; molybdenum; tantalum; stainless steel; Inconel; titanium; aluminum nitride; graphite; boron nitride; magnesium oxide; silicon nitride; diamond, Zirconia, Shapal; Rescor; sapphire; titanium diboride; tungsten carbide; and silicon carbide.

Some specific wetting plate/coating combinations that the co-inventors have found to be especially well suited for use with specific molten metals are: for jetting molten aluminum (or alloys), an aluminum nitride wetting plate 14, with the coating 15 being boron nitride. To eject molten copper (or alloy) droplets, a molybdenum wetting plate 14 with aluminum oxide as the coating 15 was found to be highly effective. To eject molten tin, a tungsten wetting plate 14, with aluminum oxide (or boron nitride) as the coating 15 was found to be very effective. To eject molten cerium, a molybdenum wetting plate 14 coated with magnesium oxide as the coating 15 was found to be very effective. Other coating materials may include, merely by way of example and without limitation, Yttria-stabilized zirconia or Aluminum Nitride.

A highly important feature and benefit of the new ejection nozzle 10 is the decoupling of the fabrication of the nozzle main body 12 from fabrication of the wetting plate 14. Decoupling the fabrication of the nozzle main body 12 from fabrication of the wetting plate 14 enables specialized manufacturing methods to be used to optimize each component of the ejection nozzle 10, thus significantly improving the overall performance. The material properties that are required for the wetting plate 14 and main body 12 are often quite different. This is especially true for the material that comprises the apertures (i.e., orifice(s)), where materials that have favorable wetting conditions are challenging to machine or form, or are very expensive in bulk form. Therefore, decoupling the production of two components enables much greater design freedom and increases reliability of the part. For example, in an MHD-LMJ system, the nozzle body has to be a non-electrically conductive material, therefore restricting material choice to almost exclusively high temperature ceramics. However, most molten metals are non-wetting on ceramics, whereas they are typically wetting on high melting point metals. Allowing the nozzle main body 12 to be made of a machinable, non-conductive ceramic, and the wetting plate 14 to be made from a wetting, high melting point metal, combines the best of both worlds.

Accordingly, then, the ejection nozzle 10 provides the significant advantage that the nozzle main body 12 has, broadly speaking, a first wetting characteristic or “wetting level”, when used with a given molten feedstock material, and the wetting plate 14 itself has a second wetting characteristic or wetting level (i.e., on its outwardly exposed surface) when used with the same molten feedstock material, with the second wetting level being less than the first. The wetting plate 14 thus has two distinct levels of wettability: the first being on its inside surface facing the interior area of the nozzle main body 12, and the second (i.e., the outwardly facing surface) while is non-wetting and thus of a lesser wettability than the nozzle main body 12 and also a lower wettability than the inside surface of the wetting plate 14, and wherein the coating 15 on the outside surface of the wetting plate provides the second level of wettability (i.e., being non-wettable).

FIGS. 3a and 3b show a nozzle assembly 100 in accordance with another embodiment of the present disclosure. The nozzle assembly 100 in this example includes a nozzle main body 102 and a wetting plate 104 having a plurality of spaced apart apertures 104a. Again, in this example the wetting plate 104 is shown secured to the nozzle main body 102 via a high temperature adhesive. However, as described above for nozzle assembly 10, a wide variety of other attachment methods could be used.

While FIG. 3b shows the apertures 104a in this example as all being of the same diameter, it will be appreciated that they need not all be of the same diameter. Furthermore, the spacing may vary between adjacent apertures 104a. In this example the apertures 104a are circular in shape and may have a typical diameter, without limitation, of between 10 μm-1000 μm. Moreover, the orifices 104a may comprise two or more different shapes and/or diameters on the single wetting plate 104. The diameter, shape and spacing of the apertures 104a in the wetting plate 104 may depend in some instances on the materials being used and/or on the specific part being made. Furthermore, the apertures 104a may be arranged in an X/Y grid pattern, or in concentric circles, or in any other configuration, and the precise configuration may depend on the materials being used, the specific part being made and/or other factors. Still further, the aperture 14 may be formed not only as a circle, but with, for example and without limitation, an oval shape, square shape, a triangular shape, a rectangular shape, star shape, or any other shape that is determined to optimize performance when making a part or when using specific molten materials. FIG. 3c shows one embodiment of the wetting plate 14n where the wetting plate includes a plurality of the apertures 14n1 formed in concentric circles. FIG. 3d shows a cross sectional side view of another embodiment of the wetting plate 140 of the present disclosure with a tapering aperture 1401, while FIG. 3e shows another embodiment of a wetting plate 14p of the present disclosure with a trumpet shaped aperture 14p1. These are but a few of many variations of the shape of the aperture(s) that may be used with the wetting plate described herein.

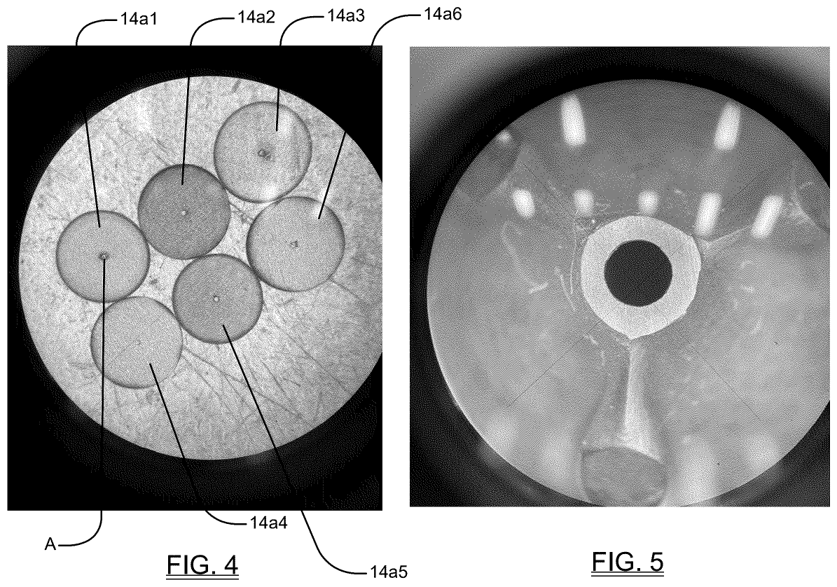

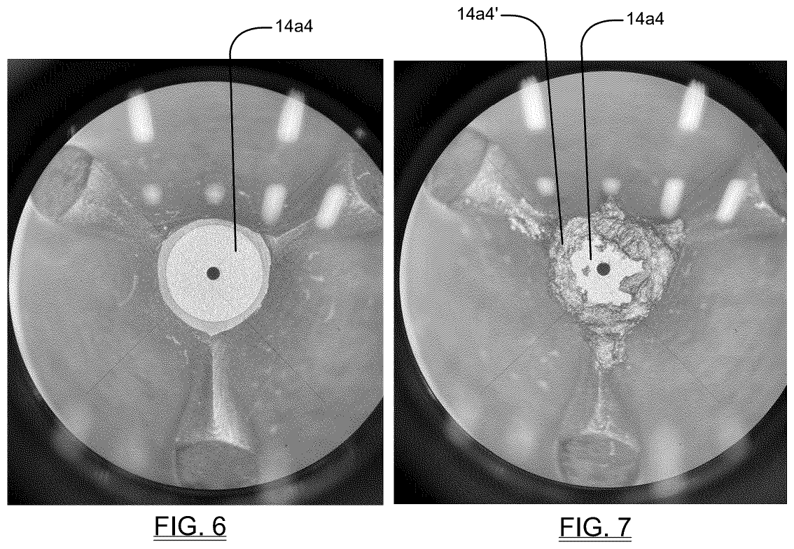

FIG. 4 shows images of wetting plates 14a1, 14a2, 14a3 and 14a4, 14a5 and 14a6 made from Tantalum, and vapor coated on one side with Al₂O₃, and with the aperture “A” in each having been laser drilled with a 500 μm aperture. FIG. 5 shows a bottom view of a nozzle body housing of a conventional nozzle housing bored out to a large aperture sufficient in diameter to mount the wetting plate 14a4 to. FIG. 6 shows the nozzle housing of FIG. 5b with the wetting plate 14a4 positioned thereover, with its Al₂O₃ coating positioned facing upward. FIG. 7 shows the wetting plate 14a4 bonded to the nozzle housing using graphite cement paste 14a4′.

A non-wetting surface (e.g. coating 15) on the outside of the nozzle wetting plate 14 allows the nozzle main body 12 and the wetting plate 14 to be cleaned more efficiently when the droplet jetting process becomes unstable. With prior art nozzles, for example with a conventional graphite nozzle that was tested which was used to eject molten aluminum droplets, a series of unwanted droplets was found to adhere to the lower face of the nozzle. Once enough of these metal droplets have attached to the nozzle face near the ejection orifice, the adhered droplets will interfere with the droplet ejection process, usually ruining performance and forcing the user to shut down the printing process to replace the nozzle. Present day cleaning solutions have limitations, one being that the cleaning process is often stochastic, especially if the molten metal reacts with the nozzle bulk material. The nozzles of the present invention discussed herein will significantly improve the nozzle cleaning process by creating a “non-stick” surface from which it is easy to clean adhered droplets.

The various embodiments of the wetting plates 14 discussed herein can be made from off the shelf ceramic, metal, composite or other refractory sheets that have favorable wetting properties for the molten metal being jetted. The sheet may then be surface functionalized on one side to create a non-wetting surface. This may involve the use of coating processes such as physical vapor deposition (PVD), chemical vapor deposition (CVD), sputtering, aerosol spraying, brush painting, oxidation, anodization, plasma cleaning, etc. The surface can also be functionalized using surface roughness or micro-pattern modification, including micro-milling, sanding, abrasion, bead blasting, shot peening, laser ablation, etching, and others.

It is important that only one side of the sheet being used to manufacture the wetting plate 14 is functionalized to create a non-wetting surface. This ensures that the reverse side, and the bulk material contained within the nozzle main housing 12a, retains its intrinsic wetting properties. After surface functionalization, the orifice(s)/aperture(s) of the wetting plate 14 can be made using any suitable process, for example and without limitation, through laser drilling, conventional milling or an appropriate etching process. It's notable that non-circular sectional shapes such as triangular, square, star-shaped, etc. can be made using laser milling. In particular, if the nozzle plate requires hundreds of apertures, sheet processing becomes advantageous. By using a large sheet, the process of making wetting plates can be highly parallelized.

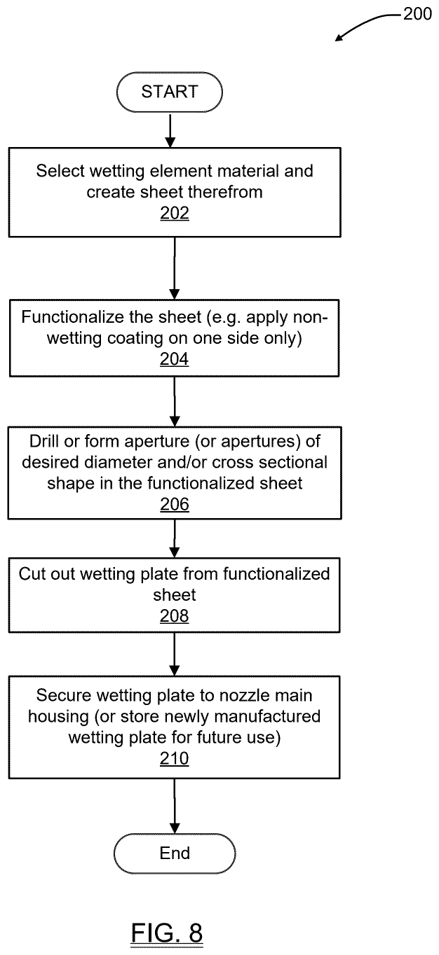

One example for fabricating LMJ nozzle wetting plates, such as wetting plate 14, may be summarized as shown in the flowchart 200 of FIG. 8. At operation 202 a sheet of desired material (e.g., Tantalum) is initially selected. At operation 204 the material sheet is surface functionalized (e.g., coated on one side with create non-wetting surface) to form a functionalized material sheet. At operation 206 the aperture (or apertures) may then be formed in the functionalized material sheet, for example by drilling or other selected means, at a desired location or in a desired pattern. At operation 208 the wetting plate may then be cut from the functionalized material sheet with the desired overall outer diameter for the wetting plate. At operation 210 the fully formed, functionalized wetting plate may then be secured to the nozzle main housing. Optionally, some or most of the order of operations discussed above may be altered. For example, the functionalized material sheet may initially be cleaned and/or post processed before drilling the orifice(s). Then the wetting plate may be cut out from the functionalized material sheet. A further cleaning or post-processing operation may then be performed on the wetting plate 14. It is also possible to reverse steps 202 and 204 if the functionalization process can be tuned to target only the outside surface, and not the inside surface(s) of the orifice(s). For example, it is possible to create a bulk nozzle with a built-in orifice, and coat the outside of the nozzle using PVD. For instances of fabrications in which functionalization processes cannot be tuned to target only the exterior plate but also coat the interior orifices with undesired non-wetting surface functionalization, additional methods can be used to apply releasable protection layers for these specific surfaces. Examples of such methods would include relevant application and curing of positive or negative photoresist into the orifice(s) prior to surface functionalization, and then subsequently dissolving the photoresist blocking layers. Other physical blocking layers could also be employed such as cured PDMS which could be removed either via physical peeling or other chemical processing.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A liquid metal jetting ejection nozzle comprising:
a nozzle main body having an enlarged opening at a distal end through which a molten metal feedstock material flows during a liquid metal jetting operation, the nozzle main body being formed from a first material having a first wetting characteristic; and
a wetting plate having an aperture and secured to the enlarged opening of the nozzle main body, the wetting plate having a second wetting characteristic of a magnitude less than the first wetting characteristic to at least inhibit wetting.

2. The liquid metal ejection nozzle of claim 1, wherein the wetting plate has an inside surface facing an interior area of the nozzle main body when secured to the nozzle main body, and an oppositely facing outside surface, and wherein the outside surface comprises a coating having the second wetting characteristic.

3. The liquid metal ejection nozzle of claim 1, wherein the wetting plate has:
an inside surface facing an interior area of the nozzle main body when secured to the nozzle main body, and having a first wetting characteristic providing a first level of wettability; and
an oppositely facing outside surface, and wherein the outside surface comprises a coating having a second wetting characteristic having a second level of wettability which is less than the first level of wettability.

4. The liquid metal ejection nozzle of claim 1, wherein the coating comprises Al₂O₃.

5. The liquid metal ejection nozzle of claim 1, wherein the coating comprises boron nitride.

6. The liquid metal ejection nozzle of claim 1, wherein the coating comprises magnesium oxide.

7. The liquid metal ejection nozzle of claim 1, wherein the wetting plate is bonded to the distal end of the nozzle main body.

8. The liquid metal ejection nozzle of claim 1, wherein the wetting plate is removably coupled to the distal end of the nozzle main body.

9. The liquid metal ejection nozzle of claim 1, wherein the nozzle main body is comprised of at least one of:
a refractory metal;
a ceramic; or
a composite including at least one of a ceramic or a refractory metal.

10. The liquid metal ejection nozzle of claim 1, wherein the aperture of the wetting plate comprises a plurality of orifices arranged in a pattern.

11. The liquid metal ejection nozzle of claim 1, wherein the pattern comprises at least one of:
an X/Y grid; or
a plurality of concentric circles.

12. The liquid metal ejection nozzle of claim 1, wherein the aperture of the wetting plate comprises an aperture of between 10 μm and 1000 μm in diameter.

13. The liquid metal ejection nozzle of claim 1, wherein the nozzle main body comprises at least one of:
tungsten;
molybdenum;
tantalum;
stainless steel;
Inconel;
titanium;
aluminum nitride
graphite;
boron nitride;
magnesium oxide;
silicon nitride;
diamond;
Zirconia;
Shapal;
Rescor;
sapphire;
titanium diboride;
tungsten carbide; and
silicon carbide.

14. A liquid metal jetting ejection nozzle comprising:
a nozzle main body having an interior area and an enlarged opening at a distal end through which a molten metal feedstock material flows through from the interior area during a liquid metal jetting operation; and
a wetting plate secured to the enlarged opening;
the wetting plate having a first surface forming an inside surface facing the interior area of the nozzle main body, a second surface opposing the first surface and forming an outer surface facing away from the interior area, and an aperture through which the liquid metal is jetted during the liquid metal jetting operation; and
the inside surface of the wetting plate having a first wettability and the outside surface of the wetting plate having a second wettability less than the first wettability to at least inhibit wetting.

15. The liquid metal jetting ejection nozzle of claim 14, wherein the outside surface of the wetting plate comprises a coating, and wherein the coating has the second wettability.

16. The liquid metal jetting ejection nozzle of claim 14, wherein the wetting plate is fixedly secured to the distal end of the nozzle main body by at least one of bonding or welding.

17. The liquid metal jetting ejection nozzle of claim 14, wherein the plate is removably secured to the distal end of the nozzle main body to facilitate removal and replacement thereof.

18. The liquid metal jetting ejection nozzle of claim 15, wherein the wetting plate comprises at least one of:
Tungsten;
Tantalum;
Stainless Steel
Inconel;
Titanium;
Aluminum Nitride;
Graphite;
Boron Nitride;
Magnesium Oxide;
Silicon Nitride;
Diamond;
Zirconia;
Shapal;
Rescor;
Macor;
Sapphire;
Titanium Diboride;
Tungsten Carbide;
Silicon Carbide; and
wherein the coating comprises at least one of:
Al₂O₃;
boron nitride;
magnesium oxide;
Yttria-stabilized zirconia; or
Aluminum Nitride.

19. The liquid metal jetting ejection nozzle of claim 14, wherein the aperture comprises a plurality of apertures arranged in a predetermined pattern.

20. A method of using a liquid metal ejection nozzle to control a location of a meniscus at an ejection aperture of the nozzle, the method comprising:
providing a nozzle main body for the liquid metal ejection nozzle to contain a quantity of a liquid metal within an interior area thereof, and feeding the liquid metal through an enlarged opening at a distal end of the nozzle main body;
using an independent wetting plate having an aperture, an inside surface facing the interior area of the nozzle main body, and secured over the enlarged opening at the distal end of the nozzle main body, to eject droplets of the liquid metal through the aperture; and
further using wetting plate such that an inner surface of the wetting plate which faces the interior area of the nozzle main body has a first degree of wettability to promote wetting, and such that an outer surface which opposes the inner surface has a second degree of wettability which inhibits wetting, such that the wetting plate helps to control a location of the meniscus such that the meniscus is contained uniformly and substantially within a cross section of the wetting plate.
